(19) United States
(12) Patent Application Publication
(10) Pub. No.: US 2026/0249785 A1
(43) Pub. Date: Aug. 27, 2026

(54) DETECTION OF OBJECTS OUTSIDE OF AN OPTICAL SENSOR FIELD OF VIEW

(71) Applicant: GM GLOBAL TECHNOLOGY OPERATIONS LLC, DETROIT, MI (US)

(72) Inventors: Tzvi Philipp, Bet Shemesh (IL); Ron Hecht, Raanana (IL); Omer Tsimhoni, Bloomfield Hills, MI (US); Ariel Telpaz, Givat Haim Meuhad (IL); Gershon Celniker, Netanya (IL)

(21) Appl. No.: 19/063,648

(22) Filed: Feb. 26, 2025

(51) Int. Cl. B60R 1/27; B60R 1/00; G02B 27/00

(52) U.S. Cl. CPC B60R 1/27; B60R 1/005; G02B 27/0056

(57) ABSTRACT

A system for detecting objects in an environment around a vehicle includes an optical sensor having a base field of view (FOV), and an optical element disposed proximate to the optical sensor, the optical element configured to receive light from a region outside of the base FOV and direct the received light to the optical sensor. The system also includes a processor configured to receive an image from the optical sensor, and detect an object in the region based on a visual artifact produced in the received image by the received light.

### INTRODUCTION

The subject disclosure relates to sensing devices and monitoring systems. More specifically, the subject disclosure relates to detection of traffic signals, traffic lights and/or other objects.

Vehicles (e.g., automobiles, trucks, aircraft, construction equipment, farm equipment, automated factory equipment) are increasingly equipped with sensor systems for monitoring surrounding environments. Optical camera, radar and/or lidar systems may be used for detection and tracking of objects, for example, to avoid obstacles. In addition, such systems may be used to monitor traffic environments including other vehicles and traffic control devices (e.g., traffic lights and stop signs), for purposes such as autonomous control and/or driver assistance.

### SUMMARY

In one exemplary embodiment, a system for detecting objects in an environment around a vehicle includes an optical sensor having a base field of view (FOV), and an optical element disposed proximate to the optical sensor, the optical element configured to receive light from a region outside of the base FOV and direct the received light to the optical sensor. The system also includes a processor configured to receive an image from the optical sensor, and detect an object in the region based on a visual artifact produced in the received image by the received light.

In addition to one or more of the features described herein, the optical element is configured to allow light within the base FOV to impinge on the optical sensor without being affected by the optical element.

In addition to one or more of the features described herein, the optical element includes a diffraction grating.

In addition to one or more of the features described herein, the diffraction grating is configured to be turned on to direct the received light, and to be turned off so that the light from the region does not impinge on the optical sensor.

In addition to one or more of the features described herein, the diffraction grating includes a body having a transparent central region, and the body is disposed so that the transparent central region corresponds to the base FOV of the optical sensor.

In addition to one or more of the features described herein, the diffraction grating is a polarized grating, the polarized grating having a first section configured to diffract the received light in a first direction, and a second section configured to diffract the received light in a second direction opposite the first direction.

In addition to one or more of the features described herein, the visual artifact is a chromatic aberration in the received image.

In addition to one or more of the features described herein, the object is a traffic light.

In another exemplary embodiment, a method of detecting objects in an environment around a vehicle includes monitoring the environment and collecting an image generated by an optical sensing device, the optical sensing device including an optical sensor having a base field of view (FOV), and an optical element disposed proximate to the optical sensor, the optical element configured to receive light from a region outside of the base FOV and direct the received light to the optical sensor. The method also includes generating the image by the optical sensing device, analyzing the image to detect a visual artifact produced in the image by the received light, and detecting an object in the region based on the visual artifact.

In addition to one or more of the features described herein, the optical element is configured to allow light within the base FOV to impinge on the optical sensor without being affected by the optical element.

In addition to one or more of the features described herein, the optical element includes a diffraction grating.

In addition to one or more of the features described herein, the diffraction grating is configured to be activated to direct the received light, and to be deactivated so that the light from the region does not impinge on the optical sensor.

In addition to one or more of the features described herein, the method includes activating the diffraction grating based on at least one of: a user input and detection of a condition of the environment.

In addition to one or more of the features described herein, the diffraction grating includes a body having a transparent central region, and the body is disposed so that the central region corresponds to the base FOV of the optical sensor.

In addition to one or more of the features described herein, the diffraction grating is a polarized grating, the polarized grating having a first section configured to diffract the received light in a first direction, and a second section configured to diffract the received light in a second direction opposite the first direction.

In addition to one or more of the features described herein, the visual artifact is a chromatic aberration in the received image.

In yet another exemplary embodiment, a vehicle system includes a memory having computer readable instructions, and a processing device for executing the computer readable instructions, the computer readable instructions controlling the processing device to perform a method. The method includes monitoring an environment around a vehicle and collecting an image generated by an optical sensing device, the optical sensing device including an optical sensor having a base field of view (FOV), and an optical element disposed proximate to the optical sensor, the optical element configured to receive light from a region outside of the base FOV and direct the received light to the optical sensor. The method also includes generating the image by the optical sensing device, analyzing the image to detect a visual artifact produced in the image by the received light, and detecting an object in the region based on the visual artifact.

In addition to one or more of the features described herein, the optical element is configured to allow light within the base FOV to impinge on the optical sensor without being affected by the optical element.

In addition to one or more of the features described herein, the optical element includes a diffraction grating.

In addition to one or more of the features described herein, the diffraction grating includes a body having a transparent central region, and the body is disposed so that the central region corresponds to the base FOV of the optical sensor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including aspects of a monitoring system, in accordance with an exemplary embodiment;

FIG. 2 depicts an optical sensing device, in accordance with an exemplary embodiment;

FIG. 3 depicts an optical element of the optical sensing device of FIG. 2, the optical element including a diffraction grating, in accordance with an exemplary embodiment;

FIG. 4 depicts an optical sensing device including a camera and a polarized diffraction grating, in accordance with an exemplary embodiment;

FIG. 5 schematically depicts a machine learning module, in accordance with an exemplary embodiment;

FIG. 6 is a flow diagram depicting aspects a of a method of monitoring an environment and detecting objects, in accordance with an exemplary embodiment;

FIG. 7 depicts an optical sensing device and aspects of an example of detecting an object outside of a camera field of view, in accordance with an exemplary embodiment; and

FIG. 8 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for monitoring an environment and detecting traffic signals and/or other bright objects. An embodiment of a monitoring system includes an optical sensor such as a camera, which has a field of view (FOV). The monitoring system also includes an optical element disposed proximate to the camera lens, which is configured to diffract or otherwise direct incident light that is outside the FOV to the camera lens. In an embodiment, the optical element is a diffraction grating.

An embodiment of a method includes detecting an abnormality or artifact in an image generated by the camera. An artifact may be a chromatic aberration (e.g., a colored smear or smudge), a ghost image, a distortion in the image or any other effect on an image due to light rays that are diffracted, refracted or otherwise directed by the optical element. The detected artifact may be correlated or associated with an object outside of the field of view. For example, a chromatic aberration in an image may be correlated with the presence of a traffic light. An approximate location of the traffic light can be inferred based on a location of the chromatic aberration in the image.

Embodiments described herein present a number of advantages. The embodiments enhance awareness by extending the field of view of optical sensors. For example, an optical sensing device described herein includes an optical sensor (e.g., camera) and an optical element such as a diffraction grating, which allows the optical sensing device to capture images in high resolution within a FOV of the optical element, while also detecting objects outside the FOV.

Embodiments address the trade-offs inherent in choosing wide and narrow FOVs, by providing the ability to detect far objects with high resolution and detect closer objects outside of a camera's FOV with sufficient accuracy. Objects can be detected outside the FOV while maintaining a desired high resolution of an image within the FOV.

Selection of a FOV is influenced by a number of criteria. For example, it is typically desired to have a FOV that is as wide as possible to allow for detection of many objects. However, an FOV that is too wide reduces resolution. Embodiments allow for selecting an FOV of a camera that is narrow enough to provide a desired resolution, while also providing for detection of objects that are not directly captured by the camera.

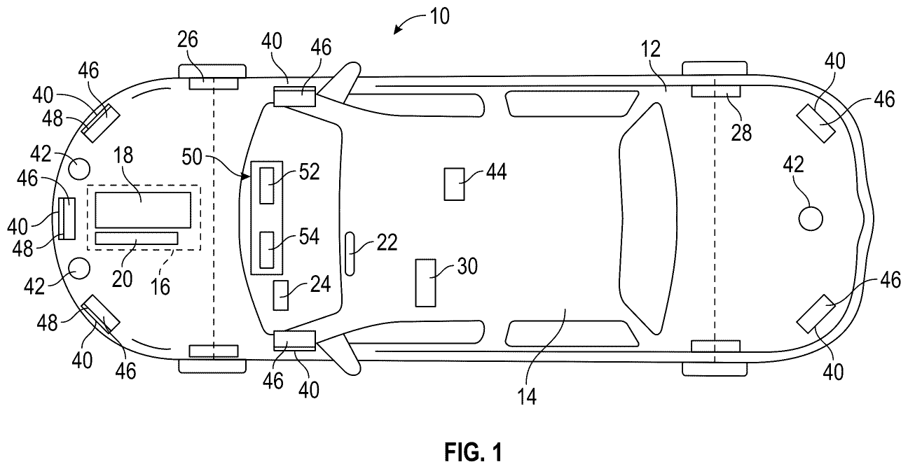

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion systems 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations.

The vehicle 10 also includes various control devices for controlling aspects of vehicle operation. Such devices include, for example, the engine 18 and the motor 20, a steering wheel 22, an acceleration pedal 24, front brakes 26 and rear brakes 28. Control devices and actuators are controllable via one or more control units, collectively represented by a controller 30.

The vehicle 10 also includes an environment monitoring system for detecting and monitoring the environment around the vehicle. The monitoring system includes, for example, one or more optical sensing devices 40 configured to take images, which may be still images and/or video images. Additional devices or sensors may be included, such as one or more radar assemblies 42 included in the vehicle 10. The monitoring system is not so limited and may include other types of sensors, such as lidar and infrared. The monitoring system may also include a monitoring unit 44 for performing functions such as controlling operation of one or more sensors (e.g., by controlling parameters of an optical element as described herein), receiving image data, processing image data, detecting objects or features, and others.

Each optical sensing device 40 includes an optical sensor 46 such as a camera 46. One or more of the optical sensing devices 40 includes an optical element 48 disposed proximate to the optical camera 46, such that the optical element 48 receives light from a region that is outside of a base field of view (FOV) of the camera 46. The received light is diffracted or otherwise directed to impinge on the optical camera's lens. As a result, a visual indication of an object outside of the base FOV is projected onto a produced image.

In an embodiment, diffracted or directed light does not produce a clear image of an object outside of the FOV, but instead causes a smear, blurring or other visual artifact. The monitoring unit 44 (or other processor) may detect and/or identify an object by analyzing the artifact.

An “artifact” as described herein refers to any distortion in the image or effect of the diffracted light on the image. The artifact may be a chromatic aberration, a brightness anomaly (e.g., an area of increased brightness), a resolution anomaly (e.g., a blurred area), or any other visual effect on the image. For example, a chromatic aberration such as a yellow, green or red smear or blob in the image can be detected and correlated with a traffic light, and a location of the smear in the image can be used to infer a direction and/or location of the traffic light.

Any number of optical sensing devices 40 may include an optical element as described herein. For example, as shown in FIG. 1, cameras 46 at the front of the vehicle 10 are equipped with optical elements for detecting objects outside of the cameras'FOVs. Embodiments are not so limited as all of the optical sensing devices 40 may include an optical element 48, or any subset thereof. For example, an optical sensing device 40 at a side of the vehicle 10 may be equipped with an optical element 48.

The vehicle 10, the monitoring system, the controller 30, the monitoring unit 44 and/or other vehicle systems include or are connected to an on-board computer system 50 that includes one or more processing devices 52 and a user interface 54. The user interface 54 may include a touchscreen, a speech recognition system and/or various buttons for allowing a user to interact with features of the vehicle.

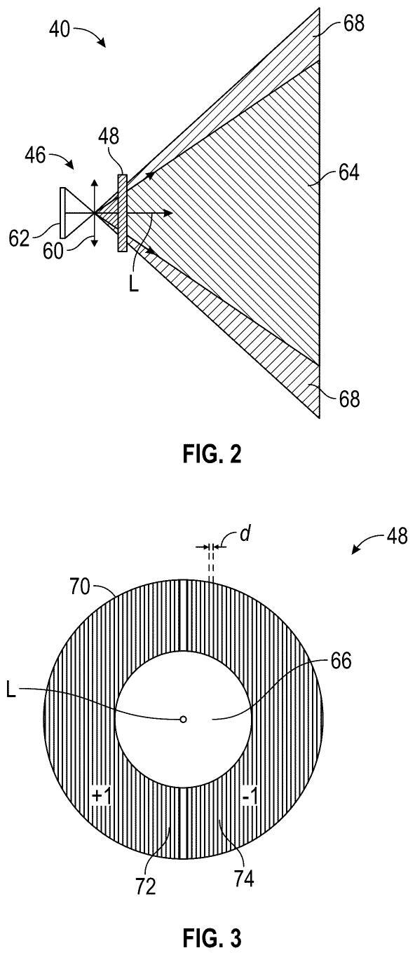

FIG. 2 depicts an embodiment of the optical sensing device 40. The camera 46 includes a lens 60 and an image sensor 62, and has a FOV 64 (referred to as a normal or base FOV 64).

The base FOV 64 has a longitudinal axis L, and is defined based on parameters of the image sensor 62 and the lens 60. For example, the FOV 64 is represented by:

$$FOV = {2}^{*} atan ( h / 2 f ) ,$$

where h is a dimension of the image sensor 62 (e.g., a dimension of a region of imaging pixels) and f is the focal length of the lens 60. The equation holds for a FOV of less than 180 degrees, where the lens is a non-fisheye lens.

The optical element 48 may be a diffraction grating 48. Although embodiments are described in conjunction with diffraction gratings, the embodiments are not so limited. Other examples of optical elements include lenses having different shapes.

For example, the embodiment of FIG. 2 includes a diffraction grating 48 that is oriented orthogonal to the longitudinal axis L. The diffraction grating 48 is circular and has a center point that aligns with the longitudinal axis L. In addition, the diffraction grating 48 includes a transparent central region 66 (shown in FIG. 3) having a size or diameter selected so that the base FOV 64 is unobstructed.

In use, the camera 46 generates a high resolution image of an area or region within the base FOV 64. Light rays from outside the base FOV 64 pass through the diffraction grating 48 and are diffracted towards the lens 60. As a result, the image includes a high resolution image of the region, and includes one or more artifacts resulting from the diffraction. In this way, objects that are outside of the base FOV 64 and within an expanded region 68 are captured. The base FOV 64 and the expanded region 68 constitute an expanded effective FOV for the optical sensing device 40.

In an embodiment, the optical element 48 is configured to be turned on and off, so that the optical sensing device 40 can be activated as desired. For example, the diffraction grating 48 is a liquid crystal grating that can be connected to a control device (e.g., the monitoring unit 44 of FIG. 1) for selectively activating detection functionality described herein.

FIG. 3 shows an embodiment of the diffraction grating 48, in the form of a ring-shaped or toroidal diffraction grating. The grating is formed on a ring-shaped or toroidal body 70. The central region 66 in this embodiment is a circular opening (or a region made from a transparent material) having a size that corresponds to the size of the lens 60, such that the base FOV of the lens 60 is not affected by the diffraction grating 48. The central region 66 is centered at the longitudinal axis L and at a location along the axis L that allows all light rays from the base FOV 64 to pass with no attenuation.

In an embodiment, the diffraction grating 48 is a polarized diffraction grating having one or more grating orders. For example, the diffraction grating 48 includes a first grating section 72 at one side of the longitudinal axis L, and a second grating section 74 at another side. The first grating section 72 is of order +1 and the second grating section 74 is of order −1. The grating sections may have any grating order, as long as light rays are appropriately directed to the lens 60 (e.g., rays through the first grating section 72 are diffracted rightward and rays through the second grating section 74 are diffracted leftward). The size, shape and grating orders of each section 72, 74 may be selected as desired.

The diffraction grating 48 may include sections having other grating orders. For example, additional regions having other grating orders (e.g., +2 and −2) may be added at the periphery of the first and second grating sections to further extend the effective expanded FOV of the optical sensing device 40. In addition, the diffraction grating or optical element 48 is not limited to any specific size or shape, and may have any size or shape such that light from the expanded region 68 (or portion thereof) is directed to the camera 46.

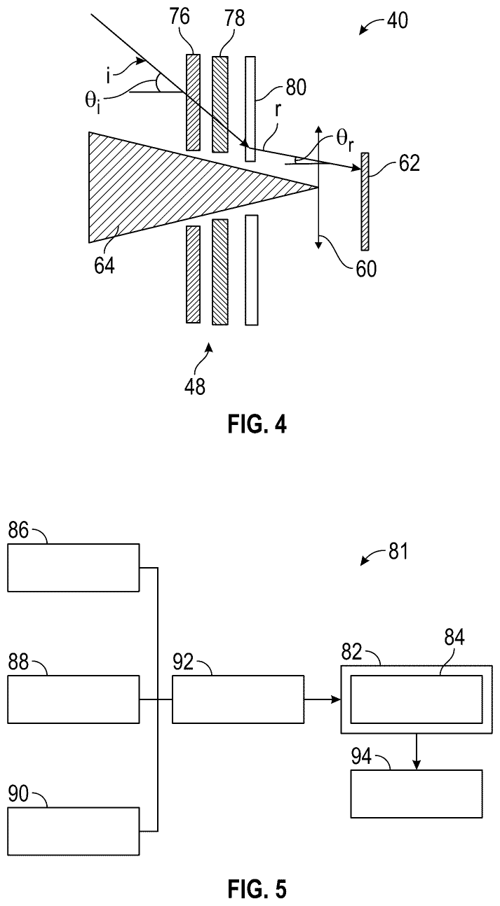

FIG. 4 is a cross section of an example of the optical sensing device 40, the polarized diffraction grating 48, and components for defining the direction of diffraction. In this example, the components are provided for giving the diffraction grating 48 a preferential diffraction order of −1 or +1. The polarized diffraction grating 48 includes a linear polarizer 76, a fixed wave plate 78 and a polarized grating 80. The linear polarizer 76 controls the polarization of an incident light beam i (outside of the base FOV 64), and is followed by the fixed wave plate 78 that translates the polarization from linear to circular. The fixed wave plate 78 may be a quarter wave plate that introduces a phase delay between components of the linearly polarized incident light beam i. The polarized grating 48 diffracts the circularly polarized light only in the −1 or +1 direction, producing a refracted ray r.

The grating 48 is designed such that an angle θᵢ of the incident beam i to the longitudinal axis L is greater than the largest marginal ray angle of the base FOV 64. A line spacing d (shown in FIG. 3) of the diffraction grating 48 is selected so that an angle θᵣ of the refracted ray r is within a cone traced via the imaging lens 60 to the imaging sensor 62. The line spacing can be represented by:

$$d = m λ ,$$

where m is the order (e.g., +1 or −1) and λ is the ray wavelength. The grating spacing is selected such that θᵣ is less than the maximal ray angle accepted by the lens 60 and the imager 62.

Detection or identification of an object in the expanded region 68 may be performed in any suitable manner. For example, different types of artifacts may be correlated with objects using a lookup table or other data structure. Other examples include machine learning techniques that utilize machine learning models trained on previously collected artifacts.

FIG. 5 depicts an embodiment of a module 81 that can be used for machine learning and identification of objects based on image artifacts. The machine learning module 81 utilizes a neural network or other machine learning model, which is trained, for example, on previously collected images. The images may be images that were collected using the optical sensing device 40, and/or other images having artifacts that correspond to known objects.

The machine learning module 81 includes a machine learning model 82. The machine learning model 82, in an embodiment, includes at least one feature space or embedding space 84.

The machine learning model 82 receives input data that includes images 86 generated by the optical sensing device 40 (or portions of images), and may include other information. Examples of other information include vehicle location data 88 (e.g., location data such as Global Positioning System (GPS) and/or Global Navigation Satellite System (GNSS) data, and map data), and operational data 90 representing operational parameters such as speed, acceleration and braking. Other information, such as locations of intersections and other areas for which an expanded FOV would be useful, may also be input to the model 82.

The machine learning module 81 is configured to convert received data into feature vectors 92, which are input to the model 82. The model 82 outputs object detection information 94. For example, the model 82 classifies an artifact in an image as an object (e.g., traffic light or other object that generates light, a bright object such as a reflective sign, etc.), and outputs information 94 identifying an object. The information 94 may include other information, such as an estimated location of the object.

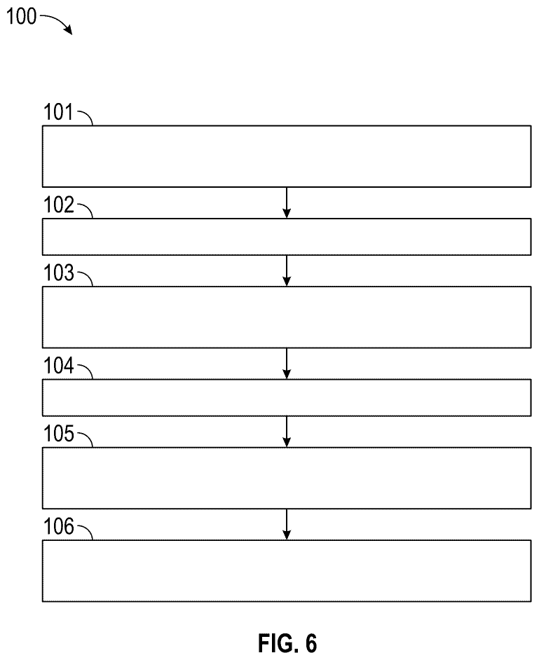

FIG. 6 illustrates embodiments of a method 100 of monitoring an environment and detecting objects. Aspects of the method 100 may be performed by the monitoring unit 44, the machine learning module 81 and/or other suitable processing device or combination of processing devices.

The method 100 is described in conjunction with the vehicle 10 of FIG. 1 and the optical sensing device 40 of FIG. 2 for illustrative purposes. Embodiments are not so limited, as the method 100 may be performed in conjunction with any suitable system.

The method 100 includes a number of steps or stages represented by blocks 101-106. The method 100 is not limited to the number or order of steps therein, as some steps represented by blocks 101-106 may be performed in a different order than that described below, or fewer than all of the steps may be performed.

At block 101, an environment around the vehicle 10 is monitored using at least one optical imaging device 40. During the monitoring, images are continuously or periodically collected.

In an embodiment, the optical imaging device 40 includes a controllable diffraction grating, which can be turned on and off. For example, the diffraction grating 48 is or includes a liquid crystal grating. Thus, in an embodiment, the optical imaging device 40 may initially capture images while the grating is turned off, yielding standard high resolution images.

At block 102, in an embodiment, the optical imaging device 40 is activated by turning on the diffraction grating 48. Activation may occur in response to various conditions and inputs. For example, the imaging device 40 may be activated manually by a user or driver. In another example, the imaging device 40 may be activated by a processing device (e.g., the monitoring unit 44 of FIG. 1) based on vehicle location and/or features of the environment. For example, the optical imaging device 40 is automatically activated based on determining that the vehicle 10 is approaching an intersection, or other location where it is expected that detection of objects outside the base FOV 64 would be useful or desirable.

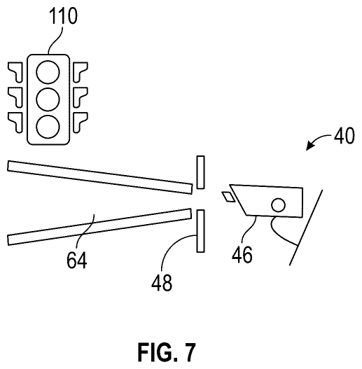

FIG. 7 depicts an example of the optical sensing device 40, which is attached to a vehicle (not shown) that is located at or near an intersection. As shown, there is a traffic light 110 located outside the base FOV 64, which would not be captured by the camera 46 alone.

Returning to FIG. 6, at block 103, images are collected while the diffraction grating is active, and light rays from inside the base FOV 64 propagate through the lens 60 and impinge on the image sensor 62. Light rays outside of the base FOV 64 (e.g., light rays generated by, or reflected from, objects in the expanded region 68) are diffracted toward the lens and also impinge on the image sensor.

At block 104, an image is analyzed to identify an artifact in the image. In the example of FIG. 7, light rays emitted by the traffic light 110 produce a red smear or smudge in a section of the image.

At block 105, the identified artifact is correlated with an object. The correlation may be performed, for example, using stored data or by classifying the artifact using the machine learning model. In the example of FIG. 7, the image (or section of the image including the red smear) is identified as a red traffic signal. In addition to detecting the object, a direction or location of the object may be determined based on a location of the artifact in the image.

At block 106, any of one or more actions may be performed based on object detection information. For example, operation of the vehicle 10 (e.g., engine rotational speed, vehicle speed, braking and others) is controlled manually or autonomously (e.g., by the vehicle controller 30) to react to the object, where applicable. Other actions include presenting an indication or notification to a user. In the example of FIG. 7, an action may be an indication to a driver that there is a red light, and/or a notification when the traffic light 110 changes.

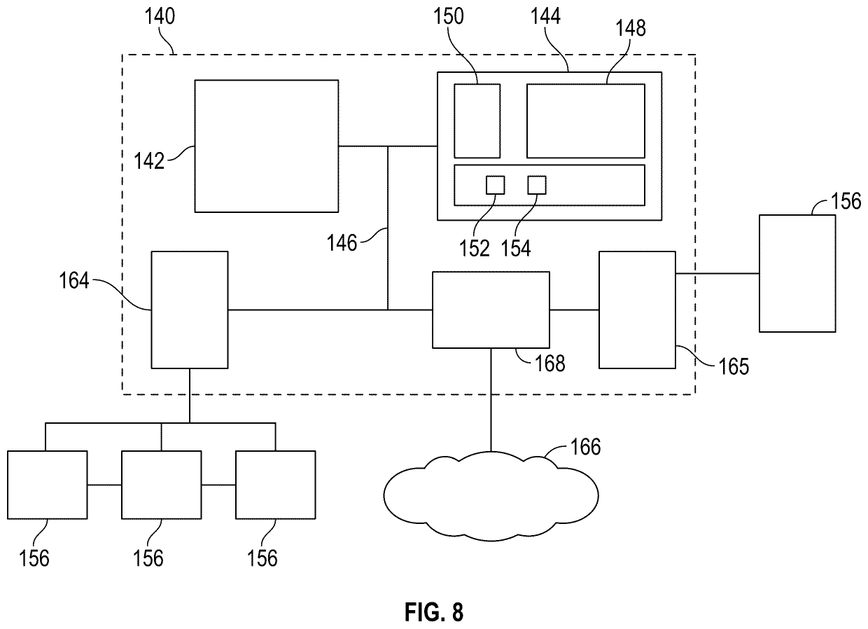

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included to perform functions such as collecting images and data, and a module 154 may be included to perform functions such as image analysis and object detection as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for detecting objects in an environment around a vehicle, comprising:
an optical sensor having a base field of view (FOV);
an optical element disposed proximate to the optical sensor, the optical element configured to receive light from a region outside of the base FOV and direct the received light to the optical sensor; and
a processor configured to receive an image from the optical sensor, and detect an object in the region based on a visual artifact produced in the received image by the received light.

2. The system of claim 1, wherein the optical element is configured to allow light within the base FOV to impinge on the optical sensor without being affected by the optical element.

3. The system of claim 1, wherein the optical element includes a diffraction grating.

4. The system of claim 3, wherein the diffraction grating is configured to be turned on to direct the received light, and to be turned off so that the light from the region does not impinge on the optical sensor.

5. The system of claim 3, wherein the diffraction grating includes a body having a transparent central region, and the body is disposed so that the transparent central region corresponds to the base FOV of the optical sensor.

6. The system of claim 4, wherein the diffraction grating is a polarized grating, the polarized grating having a first section configured to diffract the received light in a first direction, and a second section configured to diffract the received light in a second direction opposite the first direction.

7. The system of claim 1, wherein the visual artifact is a chromatic aberration in the received image.

8. The system of claim 1, wherein the object is a traffic light.

9. A method of detecting objects in an environment around a vehicle, comprising:
monitoring the environment and collecting an image generated by an optical sensing device, the optical sensing device including an optical sensor having a base field of view (FOV), and an optical element disposed proximate to the optical sensor, the optical element configured to receive light from a region outside of the base FOV and direct the received light to the optical sensor;
generating the image by the optical sensing device;
analyzing the image to detect a visual artifact produced in the image by the received light; and
detecting an object in the region based on the visual artifact.

10. The method of claim 9, wherein the optical element is configured to allow light within the base FOV to impinge on the optical sensor without being affected by the optical element.

11. The method of claim 9, wherein the optical element includes a diffraction grating.

12. The method of claim 11, wherein the diffraction grating is configured to be activated to direct the received light, and to be deactivated so that the light from the region does not impinge on the optical sensor.

13. The method of claim 12, further comprising activating the diffraction grating based on at least one of: a user input and detection of a condition of the environment.

14. The method of claim 11, wherein the diffraction grating includes a body having a transparent central region, and the body is disposed so that the transparent central region corresponds to the base FOV of the optical sensor.

15. The method of claim 14, wherein the diffraction grating is a polarized grating, the polarized grating having a first section configured to diffract the received light in a first direction, and a second section configured to diffract the received light in a second direction opposite the first direction.

16. The method of claim 9, wherein the visual artifact is a chromatic aberration in the received image.

17. A vehicle system comprising:
a memory having computer readable instructions; and
a processing device for executing the computer readable instructions, the computer readable instructions controlling the processing device to perform:
monitoring an environment around a vehicle and collecting an image generated by an optical sensing device, the optical sensing device including an optical sensor having a base field of view (FOV), and an optical element disposed proximate to the optical sensor, the optical element configured to receive light from a region outside of the base FOV and direct the received light to the optical sensor;
generating the image by the optical sensing device;
analyzing the image to detect a visual artifact produced in the image by the received light; and
detecting an object in the region based on the visual artifact.

18. The vehicle system of claim 17, wherein the optical element is configured to allow light within the base FOV to impinge on the optical sensor without being affected by the optical element.

19. The vehicle system of claim 17, wherein the optical element includes a diffraction grating.

20. The vehicle system of claim 19, wherein the diffraction grating includes a body having a transparent central region, and the body is disposed so that the central region corresponds to the base FOV of the optical sensor.
